(19) United States
(12) Patent Application Publication
(10) Pub. No.: US 2015/0262092 A1
(43) Pub. Date: Sep. 17, 2015

(54) EQUIPMENT CONTROL FOR LIGHT ELECTRIC VEHICLE

(71) Applicants: Jonathan Dorny, Goleta, CA (US); Paul Donohoe, Santa Barbara, CA (US); Anthony Taormina, Santa Barbara, CA (US)

(72) Inventors: Jonathan Dorny, Goleta, CA (US); Paul Donohoe, Santa Barbara, CA (US); Anthony Taormina, Santa Barbara, CA (US)

(21) Appl. No.: 13/713,394

(22) Filed: Dec. 13, 2012

(51) Int. Cl. G06Q 10/06

(52) U.S. Cl. CPC G06Q 10/0631

(57) ABSTRACT

The present invention discloses a system for fleet management of light electric vehicles which monitors capabilities of the light electric vehicles within the fleet. The capabilities of the light electric vehicle may include equipment and/or personnel associated with the vehicle. The capabilities may be monitored either through automatic mechanisms or manual entry of information. The system dispatches vehicles to locations to complete jobs based upon the capabilities of the vehicles. The dispatching system may be managed centrally or in a distributed manner. In a centrally managed system, the information relating to the capabilities of a vehicle is transmitted to a central station for fleet control. In a distributed system, each vehicle includes a controller for determining a status of a vehicle based upon the job requested and the capabilities of the vehicle. A vehicle is self-selected for dispatch based upon its status relative to other vehicles.

### BACKGROUND OF THE INVENTION

1. Field of the Invention

The present invention relates to control of a fleet of light electric vehicles. More particularly, it relates to monitoring the equipment present on each of a fleet of vehicles.

2. Discussion of Related Art

The market for electric bicycles and other light electric vehicles has been growing. An electric bicycle, or e-bike, is a bicycle with an electric motor used to power the vehicle in addition to the pedals. Electric bicycles use rechargeable batteries and can typically travel up to 15 to 20 miles per hour. The motor makes operation of the bicycle easier for the user, particularly on hills. The energy costs of operating electric bicycles are small. Riding an electric bicycle to work or to the store instead of taking a car has long term financial, energy conservation and health gains.

Light electric vehicles (“LEV”) are an extension of electric bicycles to include vehicle having additional features and capabilities. They may have more than two wheels. They may have additional cargo or passenger carrying capacity. Often, they do not include pedals and run only using the motor. Light electric vehicles have regulated speed restrictions which enable them to be safe in environments where automobiles or other motorized vehicles are not permitted. Light electric vehicles have advantages over automobiles in that they are more maneuverable and can travel off roads more easily. In many situations, light electric vehicles are more energy efficient than automobiles and are significantly less expensive to acquire. Thus, light electric vehicles are being used for travel within large facilities, such as military bases, colleges, housing developments, and corporate campuses. They can provide an efficient means of transportation for security, emergency and maintenance personnel around these facilities. Light electric vehicles also enable a high level of social interaction and maneuverability within pedestrian crowded environments.

The range and functionality of light electric vehicles, are limited by their power consumption. In order to maintain their low cost, limited weight and high level of maneuverability, the sizes of the motor and batteries must be restricted. This limits speed and range. When the motor or batteries are increased, the efficiency of the vehicle drops. This further limits their ability to carry additional passengers and cargo. When a facility has a fleet of light electric vehicles, the limited cargo capacity of each vehicle can be alleviated by distributing complementary sets of cargo on different vehicles and coordinating assignments based on proximity and cargo. For example, for maintenance personnel, plumbing tools and supplies could be on one vehicle and electrical tools and supplies on another. The vehicle necessary for a particular repair can be dispatched to the proper location.

With a fleet of electric vehicles, it is known to monitor the location of each vehicle. However, if vehicles have different capabilities, the location of the vehicle alone is not sufficient to determine which vehicle to send to a need. The type of vehicle, its cargo and capabilities must also be known and monitored to facilitate effective dispatch and deployment of complementary assets.

### SUMMARY OF THE INVENTION

The present invention provides a system for monitoring information about the cargo and capabilities of each light electric vehicle in a fleet. According to one aspect of the invention, the equipment on a vehicle is monitored. According to another aspect of the invention, information about the equipment on a vehicle and the operator is transmitted to a central location for fleet control of capabilities deployment. According to another aspect of the invention, equipment information is communicated to other vehicles in a peer to peer fashion. According to another aspect of the invention, the equipment is automatically monitored as it is added or removed from the vehicle. According to another aspect of the invention, equipment used on a vehicle includes a barcode which is read by a reader on the vehicle. According to another aspect of the invention, equipment used on a vehicle includes an RFID tag which is read by a reader on the vehicle. According to another aspect of the invention, personnel using the vehicle are also monitored.

### BRIEF DESCRIPTION OF THE DRAWINGS

FIG. 1 is a block diagram illustrating a monitoring system according to an embodiment of the present invention.

### DETAILED DESCRIPTION

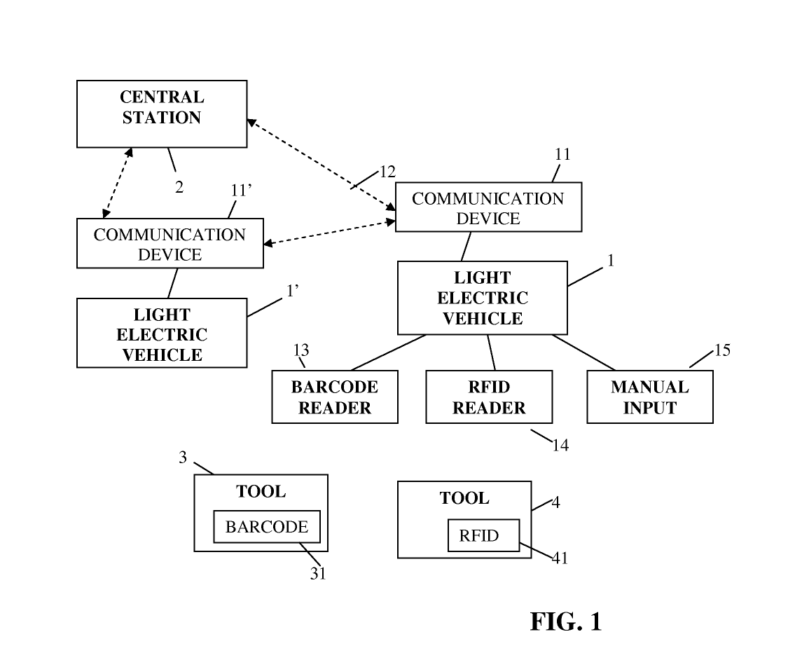

A monitoring system for a light electric vehicle 1 is illustrated in FIG. 1. The light electric vehicle 1 includes a communication device 12. The communication device 12 may be of any known type for storing information and communicating information to another location. Examples of communication devices 12 include cell phones, smart phones, tablets, computers, radios. The communication device 12 may be permanently attached to the vehicle or may be removable. The communication device 12 may include one or more parts. For example, a computer can be permanently attached to the vehicle to monitor the equipment on the vehicle. A smart phone, carried by the operator of the vehicle, may communicate with the computer to retrieve information and transmit it to another location.

The communication device 12 transmits information about the vehicle and its equipment to a central station 2 for use in fleet management and/or to other vehicles or locations within the system. The communications 11 may be over any known systems, including cellular telephone networks, WIFI, and private radio. For purposes of the monitoring system of the present invention, the communication device 12 transmits information to the central station 2 as illustrated in FIG. 1. Of course, the communication device 12 may also allow communications from the central station 2 and/or from other vehicles or locations.

Information about the equipment and/or personnel associated with the light electric vehicle is obtained by the system on the light electric vehicle. As noted above, the system may be permanently attached to the vehicle. Preferably, some portion of the information is stored with the vehicle so that it is always known and available. Different mechanisms can be used to enter information about the equipment and capabilities of the light electric vehicle. The equipment may be part of the vehicle, such as battery types, motor sizes, computer or communication device type, vehicle lighting capabilities, speakers, air compressors, etc.

The light electric vehicle includes a manual input 15 for entering information about the equipment on the vehicle. The manual input 15 may be part of or associated with the communication device 12. It may include a keyboard, touch pad, or other entry device.

Preferably, for equipment which is removable from the vehicle, an automatic system for determining when equipment is added or removed from a vehicle is used. Any type of automatic system could be used to track the equipment. Appropriate tags are included on the equipment and a corresponding reader is used on the vehicle. For example, the automatic system may include a barcode reader 13 or an RFID reader 14. Tools or equipment 3, 4 includes a barcode 31 or RFID tag 41. When the tool or equipment is added to the vehicle, the barcode 31 or RFID tag 41 is read by the appropriate reader 13, 14. The information about the tool or equipment 3, 4 is stored on the light electric vehicle 1 and/or transmitted by the communication device 12 to the central station 2.

Additionally, personnel may also carry an RFID tag so that the vehicle can monitor the persons using the vehicle. This information can also be transmitted to the central station 2 so that information regarding the personnel, such as certifications or other capabilities, can be utilized in fleet management.

The above embodiment of the invention uses a central station for fleet management and coordination of vehicles, equipment, personnel and jobs. Alternatively, the vehicles could operate as a distributed fleet management system, without the use of the central station. As illustrated in FIG. 1, the communication device 11 can communicate with a communication device 11′ of another vehicle 1′. Information about equipment in all vehicles can be maintained in a storage system (not shown) within each vehicle. Peer to peer communications can be used to coordinate the necessary equipment for various jobs.

A job can be requested from a vehicle 1, a central station 2, or another location (directly or through a central station 2). The job may include a listing of the equipment and tools necessary for the job. Alternatively, each vehicle, or the central station, may include information about equipment and tools needed for different jobs. When a job is requested, the information regarding the job is communicated to all of the vehicles (either from the central station or directly in a peer to peer system). Each vehicle evaluates its equipment and tools to determine whether it has the necessary equipment. Each vehicle also determines a time frame for response. According to an embodiment of the invention, the vehicles can use GPS information on the vehicle and information about the location of the job to determine an expected time to get to the job. Vehicles which are being used to complete other jobs may also include information about the remaining time to complete the current job. The vehicles communicate their ability, in both equipment and time, to respond to the job. The vehicle having the best response capabilities is determined through the distributed system and dispatched to the job. Multiple vehicles may respond to a job request, if more personnel or equipment is necessary than on a single vehicle. Jobs may also be categorized in relation to their importance and urgency. A vehicle may be dispatched with a job uncompleted to a more important or urgent job. The vehicle may return to the original job, or another vehicle may be used to complete the original job. Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A system for fleet management comprising:
a central station;
a plurality of light electric vehicles, each vehicle including:
at least one resource associated with the light electric vehicle;
a communication device for communicating with the central station, the communication device including:
means for communicating the at least one resource to the central station; and
means for receiving instructions from the central station.

2. The system for fleet management according to claim 1, wherein the at least one resource includes at least one of a person, a tool, and a piece of equipment.

3. The system for fleet management according to claim 1, further comprising:
means for providing information to the communication device regarding the at least one resource.

4. The system for fleet management according to claim 3, wherein the means for providing information includes an input device for entering information regarding the at least one resource.

5. The system for fleet management according to claim 3, wherein the means for providing information includes a reader for collecting information regarding the at least one resource.

6. The system for fleet management according to claim 5, wherein the reader includes a bar code reader.

7. The system for fleet management according to claim 3, wherein reader includes an RFID reader.

8. A distributed system for fleet management comprising:
a plurality of light electric vehicles, each vehicle including:
at least one resource associated with the light electric vehicle;
a controller for determining a status of the vehicle in response to a job request;
a communication device connected to the controller for communicating with at least one other of the light electric vehicles, the communication device including:
means for receiving at least one job request, and
means for communicating a status of the vehicle.

9. The distributed system for fleet management according to claim 8, wherein the at least one resource includes at least one of a person, a tool, and a piece of equipment.

10. The distributed system for fleet management according to claim 8, wherein the vehicle includes an input device for entering information regarding the at least one resource.

11. The distributed system for fleet management according to claim 8, the vehicle includes reader for collecting information regarding the at least one resource.

12. The distributed system for fleet management according to claim 11, wherein the reader includes a bar code reader.

13. The distributed system for fleet management according to claim 11, wherein reader includes an RFID reader.

14. The distributed system for fleet management according to claim 8, wherein the status of the vehicle includes a determination of whether the vehicle has resources to fulfill the job request.

15. The distributed system for fleet management according to claim 8, wherein the status of the vehicle includes a determination of a time frame to respond to the job request.

16. The distributed system for fleet management according to claim 8, wherein the controller on a vehicle determines that the vehicle has a highest status among the plurality of vehicles to respond to a job request.
